(19) United States
(12) Patent Application Publication
(10) Pub. No.: US 2021/0172247 A1
(43) Pub. Date: Jun. 10, 2021

(54) ELECTRIC ROLLER SHADE

(71) Applicant: Nien Made Enterprise Co., Ltd., Taichung (TW)

(72) Inventors: Chao-Hung Nien, Taichung (TW); Wen-Yeu Lee, Tainan City (TW); Wei-Chieh Tang, Taichung (TW)

(21) Appl. No.: 16/851,126

(22) Filed: Apr. 17, 2020

(30) Foreign Application Priority Data
Dec. 4, 2019 (TW) 108216139

(51) Int. Cl. E06B 9/40; E06B 9/72; H02J 7/00

(52) U.S. Cl. CPC E06B 9/40; H02J 7/0045; E06B 9/72

(57) ABSTRACT

An electric roller shade includes a roller shade assembly, a mounting assembly, a blocking plate, and a charging assembly. The roller shade assembly includes a roller tube, a covering material connected to and wound around the roller tube, a motor, and a power supply device. The motor is adapted to be driven by the power supply device to rotate the roller tube, whereby to retract or release the covering material. The mounting assembly includes two support brackets, between which the roller tube is disposed. The blocking plate is fixedly connected to the mounting assembly. The charging assembly includes a charging connector, which is disposed on the blocking plate and electrically connected to the power supply device, and a charging unit, which is detachably and correspondingly connected to the charging connector. When connected, the charging connector transmits electric power from the charging unit to the power supply device.

### BACKGROUND OF THE INVENTION

### 1. Field of the Invention

The present invention relates generally to an electric roller shade, and more particularly to an electric roller shade which is capable of charging a power supply device which provides electric power.

### 2. Description of the Prior Art

Generally, most electric roller shades have a motor for providing a driving force to rotate the roller tube. The power supply designed for conventional electric roller shades has a power plug that comes out from one end of the roller tube and is electrically connected to the motor; the power plug can be connected to a mains power socket, whereby to provide electric power to the motor. However, this kind of electric roller shade would have an adverse influence on the aesthetics of interior design due to the exposed cables. Furthermore, if the position where an electric roller shade is installed is remote from the mains power socket, an extension cord which connects the mains power socket and the vicinity of the installation position of the electric roller shade has to be applied to connect the power plug, thereby providing electric power to the electric roller shade. However, using an extension cord is inconvenient for users. In some countries with strict power regulations, extension cords may even require a licensed professional to perform the installation. This inconvenience also reduces users' willingness to select electric roller shades.

To address the problems previously described, some electric roller shades use batteries to provide electric power to the motor. In such cases, batteries, like the motor, can be installed in the roller tube of a roller shade; alternatively, the batteries can also be installed at a concealed position between the upper edge of the entire electric roller shade and the window frame. Either way, the use of batteries can solve the problems that the aesthetics may be marred by exposed cables and consumers' preferences for electric roller shades may be reduced because of the inconveniences in constructing the extension cords. However, after using this kind of battery-powered electric roller shade for a period of time, the battery may drain, making the electric roller shade inoperable, and therefore the battery must be replaced. No matter where the batteries are installed, e.g., in the roller tube of a roller shade, or between the upper edge of the entire electric roller shade and the window frame, the batteries are located at the top end of the window frame. Users may have to use a ladder or similar tools to reach the height of the top end of the window frame just to replace the batteries, which is rather bothersome.

Therefore, to overcome the above-mentioned known problems, electric roller shades still need a solution for conveniently charging the batteries after the electric roller shade is installed, so that the batteries could have sufficient electric power to supply to the motor for lowering and retracting the covering material.

### SUMMARY OF THE INVENTION

The objective of the present invention is to provide an electric roller shade. With a charging connector disposed on the blocking plate and electrically connected to the power supply device, a connection position capable of charging the power supply device is provided. Also, by connecting the external charging unit to the charging connector, the power supply device could be charged directly. Thus, the problem of the inconvenience in replacing batteries of conventional electric roller shades could be solved. Moreover, when the charging unit is connected to the charging connector, they could remain connected by themselves, and the electric power could be transmitted from the charging unit to the power supply device. The user may charge the power supply device through the charging connector without the need to support the charging unit by hand or any additional support. After the charging is completed, the charging unit could be detached from the charging connector.

To achieve the above objective, the present invention provides an electric roller shade including a roller shade assembly, a mounting assembly, a blocking plate, and a charging assembly. The roller shade assembly includes a covering material, a roller tube, a motor, and a power supply device, wherein the covering material is connected to and wound around the roller tube. The motor is adapted to be driven by the power supply device to drive the roller tube to rotate, whereby to retract or release the covering material. The mounting assembly includes two support brackets, and the roller tube is disposed between the two support brackets. The blocking plate is connected to the mounting assembly in a fixed manner relative to the mounting assembly. The charging assembly includes a charging connector and a charging unit. The charging connector is disposed on the blocking plate and electrically connected to the power supply device, wherein the charging unit and the charging connector are detachably and correspondingly connected to each other. When the charging unit is connected to the charging connector, the charging connector transmits electric power from the charging unit to the power supply device.

With the charging connector disposed on the blocking plate and electrically connected to the power supply device, a connection position could be provided out of the roller shade assembly to connect the charging unit, and the power supply device could be charged thereby. Also, the power supply device may be charged by connecting the external charging unit to the charging connector. Thus, the inconvenience in replacing batteries for conventional electric roller shade could be eliminated. In this way, when the user connects the charging unit to the charging connector, the electric power of the charging unit could be transmitted to the power supply device through the charging connector, whereby to charge the power supply device. In addition, once the user connects the charging unit to the charging connector, the charging unit could remain connected to the charging connector by itself without needing to be supported by hand, additional supports, or other external forces. After the charging procedure of the power supply device is completed, the charging unit could be detached from the charging connector to keep the electric window covering aesthetic and safe.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will be best understood by referring to the following detailed description of some illustrative embodiments in conjunction with the accompanying drawings, in which:

FIG. 1 is a perspective view of an electric roller shade of an embodiment of the present invention, wherein the charging unit and the charging connector are engaged with each other;

FIG. 2 is another perspective view of the electric roller shade of the embodiment of the present invention, wherein the charging unit and the charging connector are disengaged from each other;

FIG. 3A is a partial enlarged view of the electric roller shade of the embodiment of the present invention, wherein a part of the case of the charging connector is presented transparently;

FIG. 3B is a side view of the electric roller shade of the embodiment of the present invention;

FIG. 4 is a partial enlarged view of the electric roller shade of the embodiment of the present invention, wherein a part of the fixing seat of the charging unit is presented transparently;

FIG. 5 is a partial sectional view of the electric roller shade of the embodiment of the present invention seen from the rear, wherein the charging unit and the charging connector are engaged with each other;

FIG. 6 is a partial sectional view of the electric roller shade of the embodiment of the present invention seen from the rear, wherein the charging unit and the charging connector are disengaged from each other;

FIG. 7 is a partial enlarged view of the electric roller shade of the embodiment of the present invention, wherein a part of the fixing seat of the charging unit is presented transparently;

FIG. 8 is a side view of FIG. 7, wherein a part of the fixing seat of the charging unit is removed;

FIG. 9 is a perspective view of an electric roller shade of another embodiment of the present invention, wherein the charging unit and the charging connector are engaged with each other; and

FIG. 10 is another perspective view of the electric roller shade of another embodiment of the present invention, wherein the charging unit and the charging connector are disengaged from each other.

### DETAILED DESCRIPTION

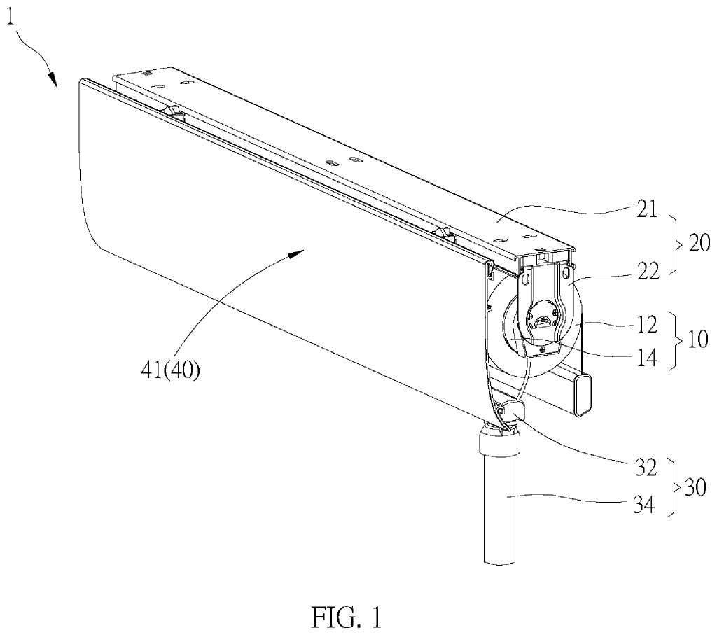

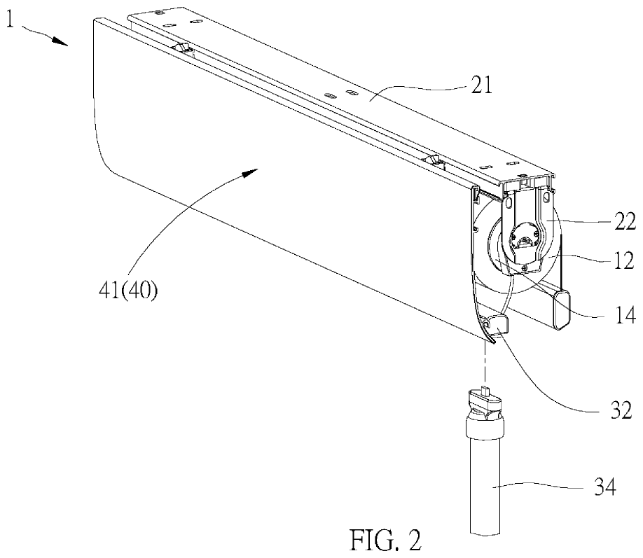

Please refer to FIG. 1 to FIG. 8, the electric roller shade 1 includes a roller shade assembly 10, a mounting assembly 20, a charging assembly 30, and a blocking plate 40. As shown in FIG. 1 and FIG. 2, the roller shade assembly 10 includes a covering material 12, a roller tube 14, a motor (not shown), and a power supply device (not shown). The motor and the power supply device are disposed in the roller tube 14 and electrically connected to each other. The power supply device provides electric power to the motor, and the motor is driven by the electric power to drive the roller tube 14 to rotate around the longitudinal axis of the roller tube 14. However, the installation positions of the motor and the power supply device are not limited to the above. In practice, one or both of the power supply device and the motor may also be installed outside the roller tube but near the position of the roller tube. One end of the covering material 12 is connected to the roller tube 14. When the roller tube 14 is rotating, the covering material 12 could be wound around the roller tube 14 to get retracted or released from the roller tube 14 to be lowered.

The mounting assembly 20 includes a mounting bracket 21 and two support brackets 22, wherein the two support brackets 22 are respectively connected to two ends of the mounting bracket 21. The roller tube 14 is disposed between the two support brackets 22, and two ends of the roller tube 14 are respectively connected to the two support brackets 22 to be supported thereby. The blocking plate 40 includes a front decorative valance 41, which is connected to the mounting bracket 21 and disposed in front of the roller tube 14, so that the front decorative valance 41 is fixed relative to the mounting bracket 21 and covers the front of the roller tube 14. In practice, the front decorative valance 41 may also be directly connected to one or both of the support brackets 22 without being connected to the mounting bracket 21, in a manner that the front decorative valance 41 is fixed relative to the support brackets 22 and covers the roller tube 14. In other words, the objective of providing the front decorative valance 41 that is fixed relative to the mounting assembly 20 and covers the front of the roller tube 14 could also be achieved in this way. In the present embodiment, the front decorative valance 41 may be used to cover at least a part of the roller shade assembly 10, so that the appearance of the electric roller shade 1 may be more compact and beautiful. Specifically, when the electric roller shade 1 is lowered, the front decorative valance 41 may cover the roller tube 14 and part of the covering material 12 which is still wound around the roller tube 14, and may therefore only expose another part of the covering material 12 that has been released from the roller tube 14.

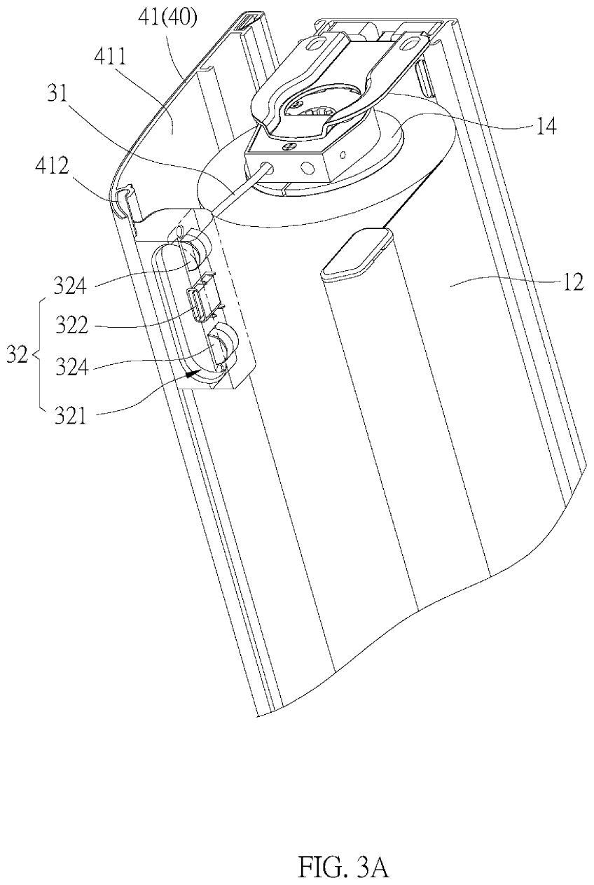

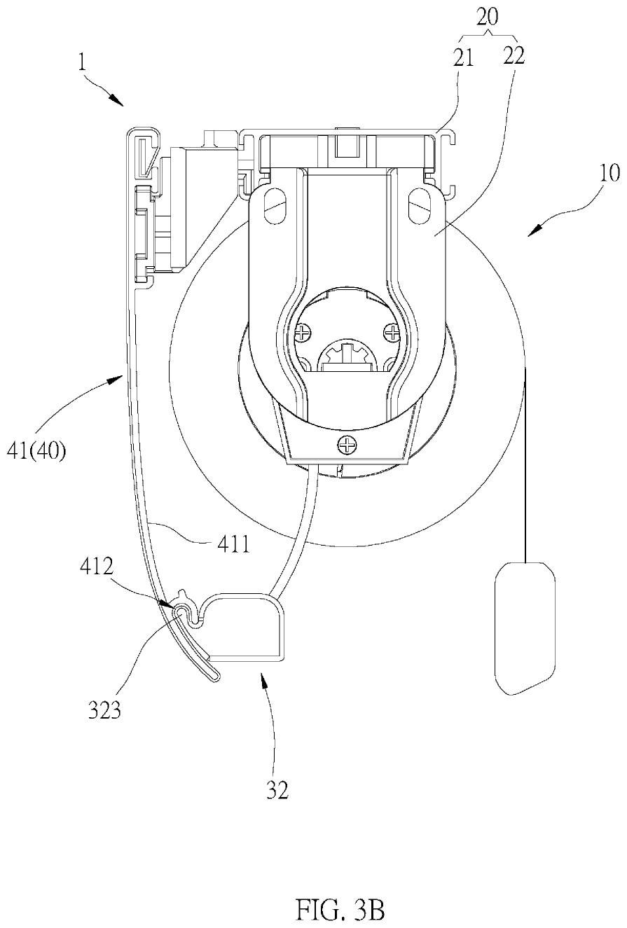

The charging assembly 30 is adapted to supply electric energy to the power supply device for charging. In the embodiment of the present invention, the charging assembly 30 includes the charging connector 32 and the charging unit 34, as shown in FIG. 1 and FIG. 2. The charging connector 32 is disposed on the blocking plate 40 and electrically connected to the power supply device. In the present embodiment, the charging connector 32 is disposed on a side surface 411, facing the roller shade assembly 10, of the front decorative valance 41 of the blocking plate 40, and is electrically connected to the power supply device disposed in the roller tube 14 through a conductive wire 31, as shown in FIG. 3A.

In FIG. 3B, the front decorative valance 41 has a side surface 411 and a guide slot 412 disposed on the side surface 411. The charging connector 32 has a flange 323, which may be correspondingly connected to and fixed in the guide slot 412, so that the charging connector 32 is fixedly disposed on the front decorative valance 41. In the present embodiment, the charging connector 32 is covered by the front decorative valance 41, so the aesthetics of the appearance of the front decorative valance 41 would not be marred. In FIG. 3A, the charging connector 32 has an electric power input member 322 and a first fixing member 324 which are disposed adjacent to each other. In the present embodiment, the first fixing member 324 is, as an example, a magnetic member having a magnetic force or a magnetic member that could be attracted by magnetic force. The first fixing member 324 may be a magnet or a magnetic attracting material (such as an iron sheet). The charging connector 32 has a recessed slot 321, and the electric power input member 322 and the first fixing member 324 are provided corresponding to the slot 321. The electric power input member 322 is a recessed-type connector, such as a socket, of which an interface may be exposed through the slot 321, while the first fixing member 324 is embedded in a bottom of the slot 321. However, this is not a limitation of the present invention.

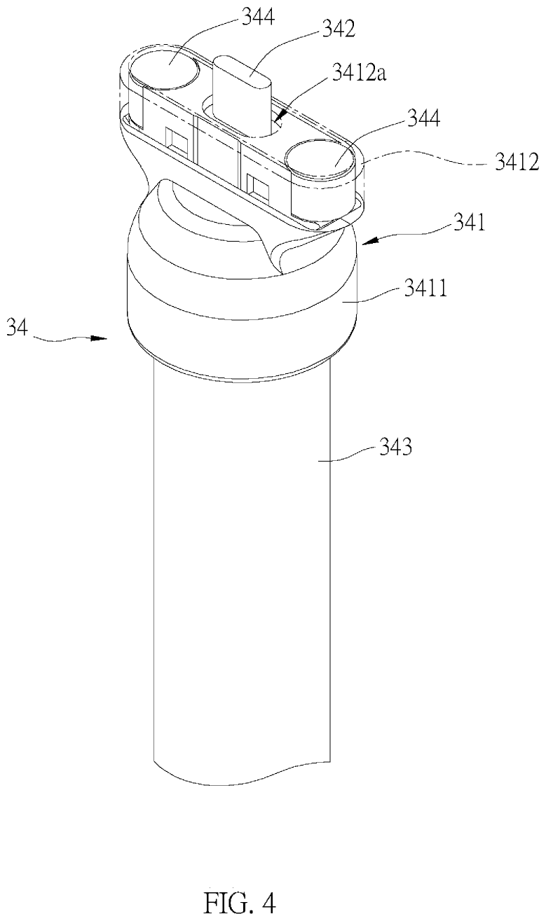

In FIG. 4, the charging unit 34 includes a fixing seat 341, an electric power output member 342, a shaft body 343, and a second fixing member 344. In the present embodiment, both the second fixing member 344 and the first fixing member 324 are magnetic members having magnetic force or magnetic members that could be attracted by magnetic force. However, the second fixing member 344 and the first fixing member 324 must be able to attract each other. For example, the first and the second fixing members 324, 344 are both magnets, so they can be attracted by each other; or, one of them is a magnet and the other is a metal that can be magnetically attracted. The fixing seat 341 has an engaging portion 3411 and an insert portion 3412 which are disposed at opposite positions. The engaging portion 3411 is connected to one end of the shaft body 343. The electric output member 342 and the second fixing member 344 are disposed adjacent to each other at the insert portion 3412. In the present embodiment, the insert portion 3412 has an opening 3412a, and a part of the electric power output member 342 protrudes out of the surface of the insertion portion 3412 through the opening 3412a; the second fixing member 344 is disposed within the insertion portion 3412. Regarding the structural configuration of the present embodiment, the insertion portion 3412 of the fixing seat 341 and the slot 321 of the charging connector 32 are correspondingly provided, and the slot 321 may accommodate at least a part of the insert portion 3412. When the insert portion 3412 goes into the slot 321, the insert portion 3412 matches the slot 321 to get connected in pairs. At the same time, the electric output member 342 and the electric power input member 322 may be connected to each other in pairs, while the first fixing member 324 and the second fixing member 344 may be paired by attraction. With these configurations, the charging unit 34 may be connected to the charging connector 32 in a detachable manner.

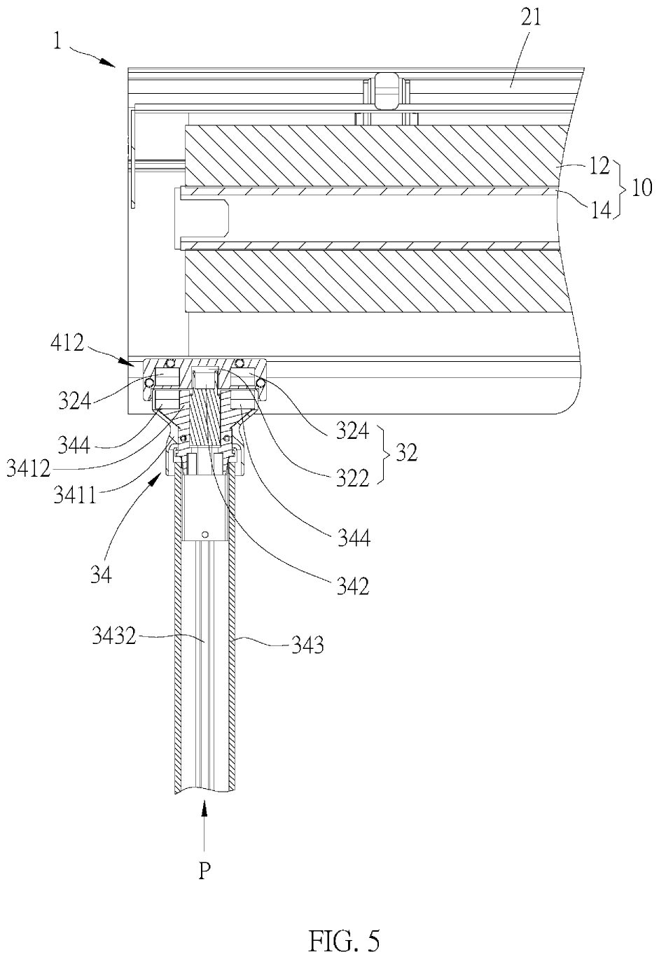

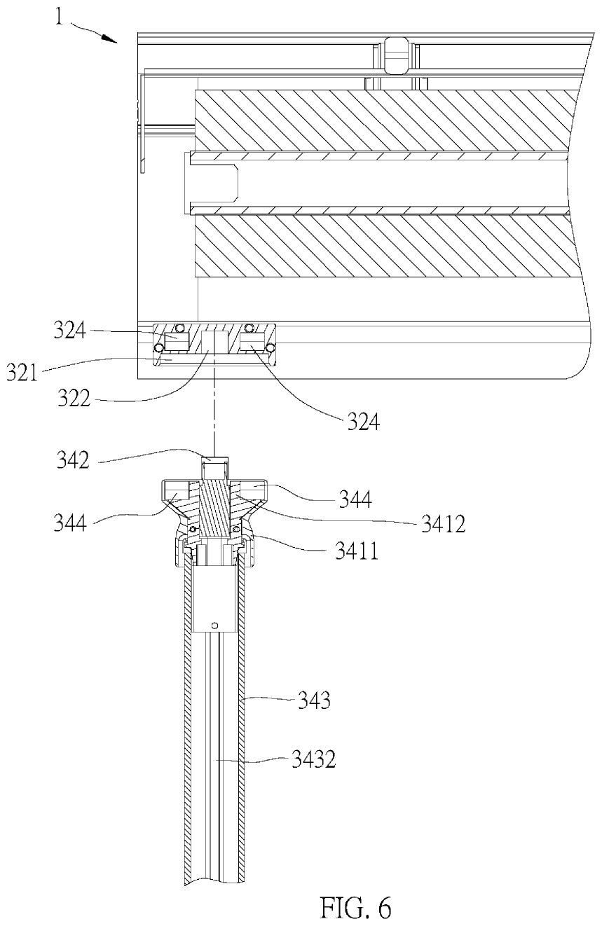

Please refer to FIG. 5 and FIG. 6 at once. FIG. 5 and FIG. 6 are both partial sectional views of the electric roller shade 1 seen from the rear. The electric output member 342 is a protruding-type connector, such as a plug, but is not limited thereto. When the insert portion 3412 of the charging unit 34 is inserted into and connected to the slot 321 of the charging connector 32, the electric power output member 342 may be inserted into the electric input member 322, establishing an electrical connection. In practice, the design of connectors of the electric power input member 322 and the electric power output member 342 is not limited thereto. Any design that can establish an electrical connection when the electric power input member 322 and the electric power output member 342 are connected should be included. In the present embodiment, the number of the first fixing member 324 is two, each of which is respectively disposed adjacent to one of two sides of the electric power input member 322. Also, the number of the second fixing member 344 is two, each of which is respectively disposed adjacent to one of two sides of the electric power output member 342. When the electric power output member 342 and the electric power input member 322 are connected, the first fixing member 324 and the second fixing member 344 may be mutually attracted at the same time and get connected, so that the insert portion 3412 could be firmly engaged within the slot 321, and the stability of the connection between the electric power input member 322 and the electric power output member 342 would be improved. In addition, through the connection of the first fixing member 324 and the second fixing member 344, the charging unit 34 could still remain connected to the charging connector 32 even if the charging unit 34 is not supported by hand, object, or any other external forces. In the present embodiment, although the first fixing member 324 and the second fixing member 344 are represented by members capable of being magnetically attracted by each other, it should be realized that they may also be any kind of fixing members that can be detachably and correspondingly connected, such as tightly fitted fixing members having complementary shapes, which may also provide the effect of keeping the charging unit 34 connected to the charging connector 32 while they can still be easily separated. Therefore, the first fixing member 324 and the second fixing member 344 are not limited to be magnetic members.

In FIG. 5, the shaft body 343 includes an electric power transmission circuit 3432 which is electrically connected to the electric power output member 342. In the present embodiment, the shaft body 343 may accommodate a battery-type power supply device therein or may be directly connected to an external electric power source (such as mains electricity or a portable charger). The electric power P could be transmitted to the electric power output member 342 through the electric power transmission circuit 3432. If a user wants to charge the power supply device of the electric roller shade, he/she could hold and move the shaft body 343 of the charging unit 34 to have its insert portion 3412 inserted into and connected to the slot 321 of the charging connector 32, without the need to use a ladder or similar tools. Since the first fixing member 324 and the second fixing member 344 are attracted and connected to each other, the insert portion 3412 could be firmly connected to the slot 321. Meanwhile, the correspondingly provided electric power output member 342 and the electric power input member 322 are also electrically connected, so that the electric power P transmitted to the electric power output member 342 could be transmitted to the power supply device through the electric power input member 322, whereby to charge the power supply device. After the user holds and moves the shaft body 343 to have the charging unit 34 and the charging connector 32 correspondingly engaged, the charging unit 34 and the charging connector 32 may remain firmly connected through the attraction force and connection generated and established between the first fixing member 324 and the second fixing member 344, and therefore the user could let go the shaft body 343 and leave it at where it is. In this way, while the power supply device is being charged, the charging unit 34 could remain connected to the charging connector 32 by itself, and would not need the support from hands, external forces, or any additional supporter.

In the present embodiment, the electric power output member 342 and the electric power input member 322 are connectors having physical electrical connection, but this is not a limitation of the present invention. The electric power output member 342 and the electric power input member 322 may also be the type that transmits electric power through induction coils. In the manner of transmitting electric power by induction, the electric power output member 342 only needs to be adjacent to the electric power input member 322, and does not need a physical electrical connection. That is, after the user holds the shaft body 343 and moves the charging unit 34 to have the insert portion 3412 of the charging unit inserted into and connected to the slot 321 of the charging connector 32, the insert portion 3412 may be firmly connected into the slot 321 through the attraction and connection between the first fixing member 324 and the second fixing member 344. At this time, the electric power output member 342 is correspondingly adjacent to the electric power input member 322, and the electric power P could be transmitted from the electric power output member 342 to the electric power input member 322 through induction coils.

In FIG. 6, when a user holds the shaft body 343, without using a ladder, and moves the charging unit 34 in a direction away from the charging connector 32 until the first fixing member 324 and the second fixing member 344 are no longer attracted by and connected to each other, the charging unit 34 is detached from the charging connector 32. At this time, the electric power P of the electric power output member 342 would no longer be transmitted to the electric power input member 322, and the electric power P supplied to the power supply device would be therefore stopped. That is, the charging procedure of the power supply device is terminated.

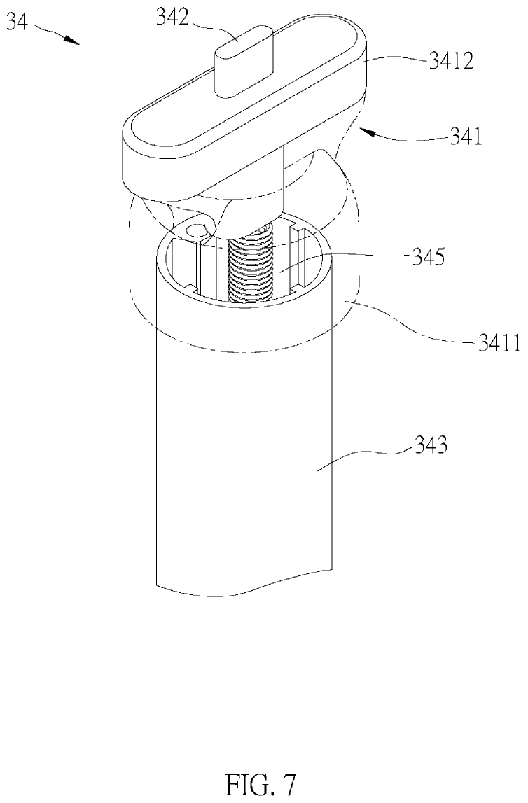

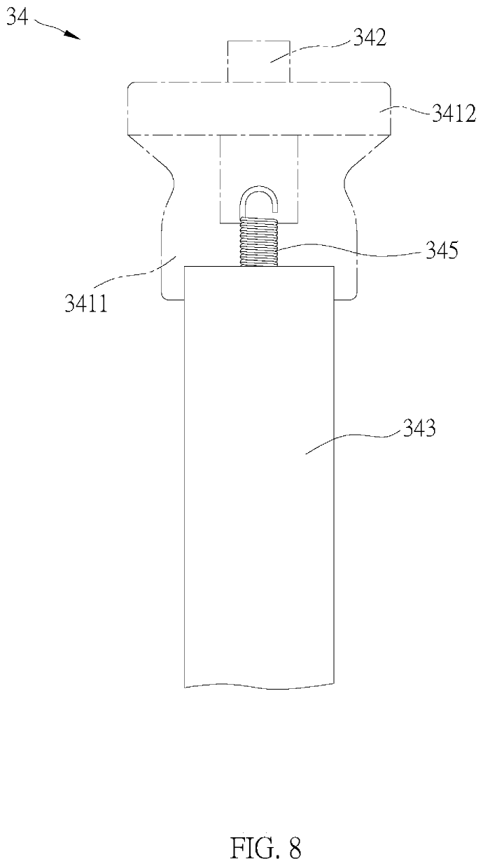

Next, please refer to FIG. 7 and FIG. 8. The charging unit 34 further includes a cushion member 345. The cushion member 345 is disposed between the shaft body 343 and the engaging portion 3411 of the fixing seat 341. In the present embodiment, one end of the cushion member 345 is connected to the shaft body 343 while the other end is connected to the engaging portion 3411. In the present embodiment, the cushion member 345 is a vibration-absorbing spring, and the shaft body 343 and the engaging portion 3411 are respectively equipped with a fixing pin (not shown) to fix two ends of the spring. When the charging unit 34 is connected to the charging connector 32, and the shaft body 343 is shaken by an external force (e.g., being accidentally hit by the user), the vibration could be absorbed by the spring to avoid affecting the attraction and connection between the first fixing member 324 of the charging connector 32 and the second fixing member 344 of the charging unit 34, as well as the corresponding connection between the electric power output member 342 and the electric power input member 322 or the stability in the vicinity.

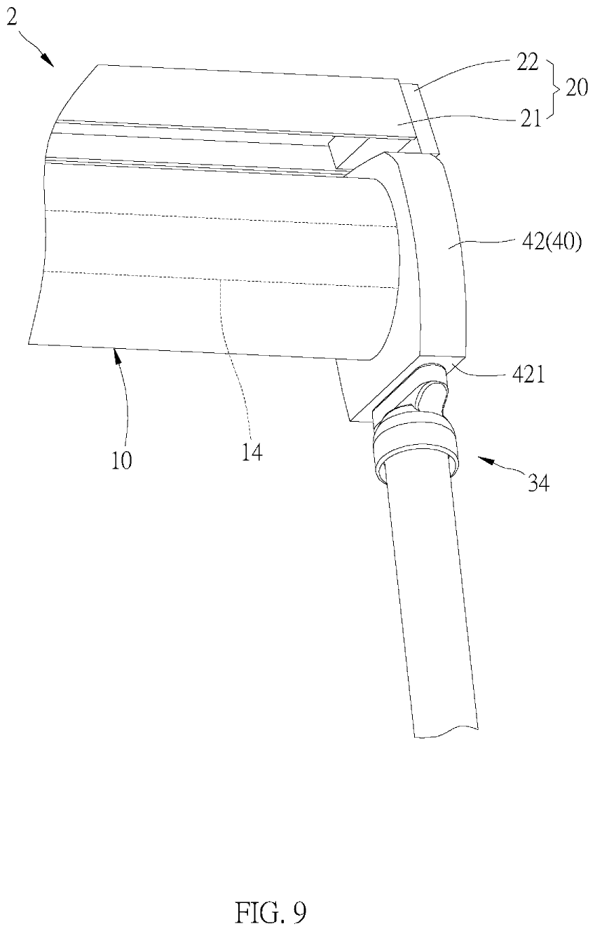

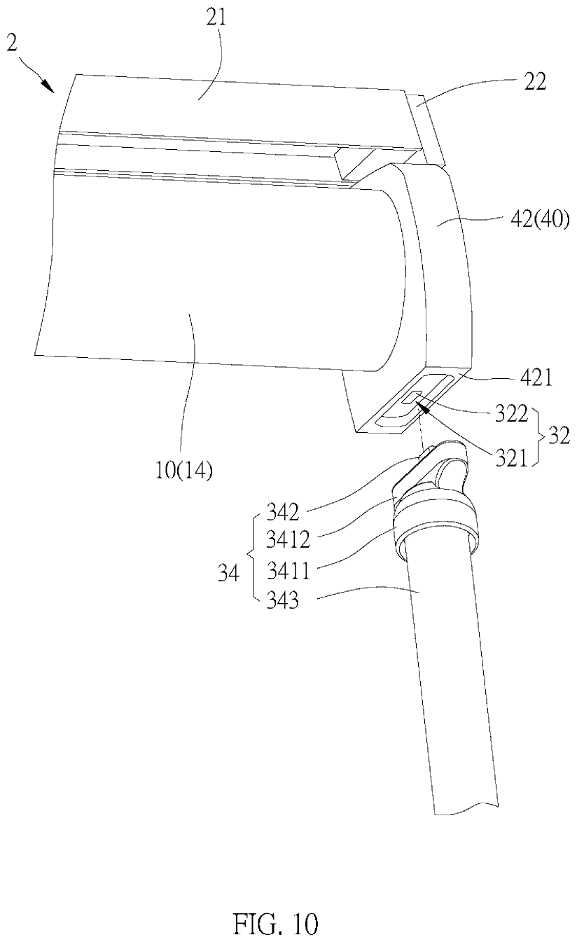

Please refer to FIG. 9 and FIG. 10. The blocking plate 40 of the electric roller shade 2 includes an end plate 42. The end plate 42 is disposed at one end of the roller tube 14 of the roller shade assembly 10. Specifically, in the present embodiment, the end plate 42 is disposed between one end of the roller tube 14 and the support bracket 22. The end plate 42 is connected to the roller tube 14, the support bracket 22 is connected to the endplate 42, and the charging connector 32 is disposed at a bottom surface 421 of the end plate 42. Accordingly, the conductive wires used for the interconnection established between the charging connector 32 and the power supply device disposed inside the roller tube 14 may be hidden in the end plate 42 and the roller tube 14 instead of being exposed. In FIG. 10, the slot 321 of the charging connector 32 is formed by recessing the bottom surface 421 of the end plate 42. The electric power input member 322 is disposed in the slot 321. Furthermore, as in the previous embodiment, a first fixing member (not shown) may be embedded in the slot 321. When the insert portion 3412 of the charging unit 34 in FIG. 10 is inserted into the slot 321, the electric power output member 342 would be in direct contact with the electric power input member 322 and generate an electrical connection to transmit electric power by the corresponding connection between the first fixing member (not shown) of the charging connector 32 and the second fixing member 344 (shown in FIG. 4) of the charging unit 34; alternatively, the electric power output member 342 could be located adjacent to the electric power input member 322 without physical contact to transmit the electric power in an inductive manner, as shown in FIG. 9. At this time, the charging unit 34 and the charging connector 32 could remain in a connected state by themselves, and the electric power of the charging unit 34 could be transmitted to the power supply device through the electric power output member 342 and the electric power input member 322, whereby to charge the power supply device.

By the design of the present invention, the electric roller shade could provide a connection position for charging the power supply device through a charging connector which is electrically connected to the power supply device. Also, the charging connector of the power supply device is disposed at the front decorative valance or the end plate of the blocking plate in a manner that the charging connector is exposed out of the roller shade assembly without affecting the overall appearance and the mounting of the electric window blind. In addition, since the power supply device could be charged through the connection of the external charging unit and the charging connecter, the troublesome and burdensome task in replacing the batteries of conventional electric roller shades or in arranging wires to use the mains electricity could be resolved. Also, when the charging unit is connected to the charging connector, they could remain in a connected state by themselves, and the electric power could be transmitted from the charging unit to the power supply device. In other words, a user may charge the power supply device through the charging connector without using hands or any additional supporter to support the charging unit, making it easy to perform the charging operation. After the charging is completed, the charging unit may be detached from the charging connector to maintain the overall aesthetics and safety of the electric window blind.

It must be pointed out that the embodiments described above are only some preferred embodiments of the present invention. All equivalent structures which employ the concepts disclosed in this specification and the appended claims should fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric roller shade, comprising:
a roller shade assembly comprising a covering material, a roller tube, a motor, and a power supply device, wherein the covering material is connected to and wound around the roller tube, and the motor is adapted to be driven by the power supply device to drive the roller tube to rotate, whereby to retract or release the covering material;
a mounting assembly comprising two support brackets, wherein the roller tube is disposed between the two support brackets;
a blocking plate connected to the mounting assembly in a fixed manner relative to the mounting assembly; and
a charging assembly comprising a charging connector and a charging unit, wherein the charging connector is disposed on the blocking plate and electrically connected to the power supply device, wherein the charging unit and the charging connector are detachably and correspondingly connected to each other; when the charging unit is connected to the charging connector, the charging connector transmits electric power from the charging unit to the power supply device.

2. The electric roller shade as claimed in claim 1, wherein the blocking plate comprises a front decorative valance, which is connected to the mounting assembly and disposed in front of the roller shade assembly to cover at least apart of the roller shade assembly, and the charging connector is disposed on a side surface, facing the roller shade assembly, of the front decorative valance and is electrically connected to the power supply device through a conductive wire.

3. The electric roller shade as claimed in claim 1, wherein the blocking plate comprises an end plate, which is connected to an end of the roller tube and the mounting assembly, wherein the charging connector is disposed at a bottom surface of the end plate.

4. The electric roller shade as claimed in claim 1, wherein the charging unit has an electric power output member, and the charging connector has an electric power input member, wherein the electric power output member and the electric power input member are detachably and correspondingly connected to each other; when the charging unit is connected to the charging connector, the electric power output member matches the electric power input member to transmit the electric power.

5. The electric roller shade as claimed in claim 4, wherein the charging connector has a first fixing member, which is disposed adjacent to the electric input member, and the charging unit has a second fixing member, which is disposed adjacent to the electric output member, wherein the first fixing member and the second fixing member are detachably and correspondingly connected to each other; when the first fixing member and the second fixing member are correspondingly connected, the charging unit and the charging connector remain connected by themselves.

6. The electric roller shade as claimed in claim 5, wherein the first fixing member and the second fixing member are respectively made of a magnetic material, and the first fixing member and the second fixing member are detachably and correspondingly adsorbed to each other; when the first fixing member and the second fixing member correspondingly attract each other and get connected, the charging unit and the charging connector remain connected by themselves.

7. The electric roller shade as claimed in claim 4, wherein one of the electric power output member and the electric power input member is a plug while the other is a socket, wherein the plug is detachably and correspondingly inserted into the socket.

8. The electric roller shade as claimed in claim 4, wherein a coil induction is performed between the electric power output member and the electric power input member to transmit the electric power.

9. The electric roller shade as claimed in claim 4, wherein the charging unit further comprises a shaft body and a fixing seat, wherein the fixing seat has an engaging portion and an insert portion; the engaging portion is disposed opposite to the insert portion, wherein the engaging portion is connected to an end of the shaft body, and the charging connector has a slot recessed inward; the insert portion of the charging unit is adapted to be inserted into the slot.

10. The electric roller shade as claimed in claim 9, wherein the insert portion has an opening, and a part of the electric power output member protrudes out of the opening.

11. The electric roller shade as claimed in claim 9, wherein the shaft body comprises an electric power transmission circuit which is connected to the electric power output member.

12. The electric roller shade as claimed in claim 9, wherein the charging unit further comprises a cushion member, which is disposed between the shaft body and the engaging portion of the fixing seat.

13. The electric roller shade as claimed in claim 12, wherein the cushion member is a coil spring.
